(19) United States
(12) Patent Application Publication
(10) Pub. No.: US 2015/0084480 A1
(43) Pub. Date: Mar. 26, 2015

(54) DEVICE FOR CONVERTING HEAT ENERGY INTO MECHANICAL ENERGY WITH IMPROVED EFFICIENCY

(71) Applicant: Commissariat a I'energie atomique et aux ene alt, Paris (FR)

(72) Inventors: Guillaume Savelli, Grenoble (FR); Philippe Coronel, Barraux (FR)

(73) Assignee: Commissariat a l'energie atomique et aux ene alt, Paris (FR)

(21) Appl. No.: 14/398,340

(22) PCT Filed: Apr. 29, 2013
(86) PCT No.: PCT/EP2013/058833

§ 371 Date: Oct. 31, 2014

(30) Foreign Application Priority Data
May 2, 2012 (FR) 1254003

(51) Int. Cl. H02N 2/18; H02N 1/08; F03G 7/06; H02K 7/18

(52) U.S. Cl. CPC H02N 2/18; H02K 7/1892; H02N 1/08; F03G 7/06
USPC 310/300; 290/1 R; 310/339; 60/529

(57) ABSTRACT

The invention relates to a device for converting heat energy into mechanical energy comprising a first (4) and a second (6) bistable area passing from a first stable state to a second stable state by means of a thermal effect or mechanical action, said areas (4, 6) being mechanically coupled such that the passage from one state to the other of one area (4, 6) by means of a thermal effect causes the other area (6,4) to pass from one state to the other, each area (4, 6) having a blistering temperature and an unblistering temperature, the blistering temperature being higher than the unblistering temperature. Said device is intended to be placed in contact with an environment (SC) having at least one given temperature, such that the temperature of the environment (SC) is lower than the blistering temperature of the first area (4) and is higher than the blistering temperature (Tc6) of the second area (6).

### TECHNICAL FIELD AND PRIOR ART

The present invention relates to a device for converting heat energy into mechanical energy with improved efficiency, said mechanical energy can be converted into electrical energy.

Electronic circuits, when in operation, produce heat. Said heat is not used and has to be evacuated so as not to damage the circuits. Other heat sources are also present in our environment, such as for example pipes, exhaust systems, the walls of industrial machinery, etc., in which the heat released is not used.

It is envisaged to recover said heat for example to convert it into electrical energy.

It may for example be envisaged to use bimetallic strips, these are formed of two strips of different metals, materials or alloys with different expansion coefficients, flexible, welded or bonded to each other, in the direction of the length.

Due to the different expansion coefficients of the two strips, the bimetallic strip deforms with a great amplitude both when it is heated and when it is cooled. When it is heated, it passes from a substantially flat shape to a shape having a certain curvature. The orientation of the curvature depends on the temperature to which it is subjected, and the initial properties of the material (thickness, thermal expansion coefficients, etc.). This deformation is converted into electrical energy by a transducer, for example a piezoelectric material that is deformed or shocked when the bimetallic strip bends.

The energy transmitted to the piezoelectric material, and thus the energy recovered, are not optimal.

Preformed bimetallic strips also exist, which have a first and a second stable state as a function of the temperature to which they are subjected.

In each of the stable states, they have a curvature or deformation, the curvatures or deformations of the two stable states being in the majority of cases opposite. These bimetallic strips are also designated “blistering bimetallic strips”. When such bimetallic strips are heated and pass from a first stable state to a second stable state, this is known as “blistering”, and when the bimetallic strips are cooled down, and pass from the second stable state to the first stable state, this is known as unblistering. During blistering and unblistering, a large amount of energy is released.

Each bimetallic strip comprises a blistering temperature and an unblistering temperature. Thus, when the bimetallic strip is arranged between a hot source, for example an electronic device, the temperature of which is higher than its blistering temperature, and a cold source, for example the exterior environment, the temperature of which is lower than its blistering temperature, the bimetallic strip is heated and passes from a first stable position to its second stable position, and when it cools, passes from its second position to its first stable position.

Such a system requires the presence of a hot source and a cold source. Yet, it may be difficult to have available an environment provided with such sources having substantially different temperatures and arranged in a sufficiently close manner to be able to have a thermal influence on the bimetallic strip.

### DESCRIPTION OF THE INVENTION

It is consequently an aim of the present invention to offer a device for converting heat energy into mechanical energy implementing bimetallic strips that can operate in an environment having one given temperature or two given temperatures.

The aforementioned aim is attained by a device comprising at least two bistable areas mechanically coupled such that the passage from one stable state to the other of one of the bistable areas causes the passage from one stable state to the other of the other bistable area. To do so, the bistable areas have different blistering and unblistering temperatures, and they are chosen as a function of the temperature(s) of the environment in which the device is placed.

In other words, the device comprises an array of at least two bistable areas having different thermal properties and arranged sufficiently close to each other so that they are under mutual mechanical influence, the blistering of a bistable area by means of a thermal effect drives the blistering of the neighbouring bistable area by mechanical deformation even if the latter has not reached its blistering temperature.

Thus, the device can operate depending on the blistering temperatures of different areas, in the absence of a hot source and a cold source, since the mechanical influence of one bimetallic strip on the other replaces the necessity of having available two heat sources at different temperature. It can also operate in an environment having two temperatures, the bimetallic strips being formed as a function of this or these temperatures.

For example, in the case of an environment at a given temperature, each of the bistable areas has blistering and unblistering temperatures such that, compared to the temperature of the environment in which they are arranged, the bistable areas “blistere” and “unblistere” alternately either by thermal effect, or by mechanical influence.

The subject-matter of the present invention therefore is a device for converting heat energy into mechanical energy comprising at least one first and one second bistable area, able to pass from a first stable state to a second stable state by means of a thermal effect or mechanical action, said bistable areas being mechanically coupled such that the passage from one stable state to the other of one of the bistable areas by means of a thermal effect causes the passage from one stable state to the other of the other bistable area, each of said bistable areas having a first temperature at which it passes from the first stable state to the second stable state and a second temperature at which it passes from the second stable state to the first stable state, the first temperature being higher than the second temperature, the first temperature of the first bistable area being higher than the first temperature of the second bistable area, said device being intended either to be arranged in an environment having a given temperature or in contact with a surface at a given temperature, such that the given temperature is lower than the first temperature, is lower than the second temperature of the first bistable area and is higher than the first temperature of the second bistable area, or to be subjected to a first given temperature and a second given temperature such that the first given temperature is higher than the second given temperature and such that the first given temperature is lower than the first temperature of the first bistable area and is higher than the first temperature of the second bistable area and the second given temperature is lower than the second temperature of the first bistable area.

The bistable areas are advantageously made in a single piece from a bimetallic strip element.

In one embodiment example, the bistable areas are made of a trimetallic strip element.

The trimetallic strip element may comprise two opposite faces, bistable areas being formed in each of the faces.

The bistable areas may be formed by pressing.

Advantageously, the bistable areas comprise a central depression and an annular area surrounding the central depression, said annular areas overlapping or being in contact via their external contours.

In an advantageous embodiment example, the device comprises a plurality of bistable areas arranged alongside each other such that neighbouring bistable areas have different first temperatures.

Said device may also comprise hollowed out portions between the bistable areas.

Another subject-matter of the present invention is an assembly for converting heat energy into electrical energy, comprising at least one conversion device according to the invention and an environment or a surface at a given temperature.

For example, the given temperature is lower than the first temperature of the first bistable area and than the second temperature of the first bistable area and is higher than the first temperature of the second bistable area.

Another subject-matter of the present invention is an assembly for converting heat energy into electrical energy, comprising at least one conversion device according to the invention and an environment having a first given temperature and a second given temperature in which the first given temperature is lower than the first temperature of the first bistable area and is higher than the first temperature of the second bistable area and the second given temperature is lower than the second temperature of the first bistable area.

The conversion assembly may comprise two conversion devices.

Another subject-matter of the present invention is a system for generating electrical energy comprising at least one conversion device according to the invention, and means for converting the mechanical energy generated by said conversion device into electrical energy.

In an embodiment example, the means for converting the mechanical energy generated by said conversion device into electrical energy may comprise at least one element made of piezoelectric material arranged on the conversion device so as to be deformed by the changes of state of the bistable areas.

In a variant, the generating system may comprise a stack of conversion devices according to the invention in which the means for converting the mechanical energy generated by said stack of conversion devices into electrical energy comprise at least one element made of piezoelectric material arranged on an electrical energy conversion device situated at one end of the stack.

In another embodiment example, the means for converting the mechanical energy generated by said conversion device into electrical energy comprise at least one variable capacity capacitor, an electrode of said variable capacity capacitor being formed or borne by the electrical energy conversion device.

### BRIEF DESCRIPTION OF THE DRAWINGS

The present invention will be better understood through the description that follows and the appended drawings in which:

FIGS. 1A to 1D are schematic representations of a recovery device with two bistable areas according to the invention in different states, arranged in an environment at substantially constant temperature,

FIGS. 2A to 2D are schematic representations of a recovery device with two bistable areas according to the invention in different states, in an environment having two temperatures,

FIGS. 3A and 3B are schematic representations of two examples of recovery devices with two bistable areas according to the invention,

FIGS. 4A and 4B are schematic representations of two examples of electricity generating devices,

FIG. 5 is a top view of a recovery device comprising an array of bistable areas according to the invention,

FIG. 6 is a schematic representation of an electricity generating device formed of a stack of recovery devices.

### DETAILED DESCRIPTION OF PARTICULAR EMBODIMENTS

In the description that follows, the device that will now be described comprises two deformation areas, however the present invention relates to devices comprising n areas able to deform under the effect of temperature, n being a positive whole number greater than or equal to 2.

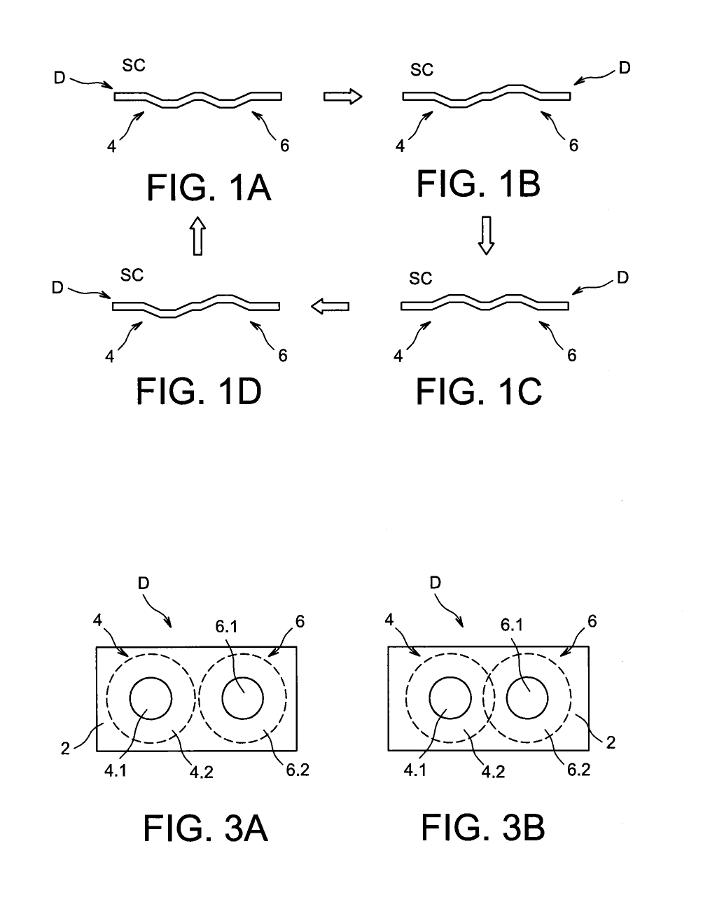

In FIGS. 1A to 1C may be seen a schematic example of a conversion device D according to the invention in different states.

The device D is formed of a bimetallic strip 2 in plate form.

As has been indicated previously, a bimetallic strip is formed of two strips made of different metal or alloy having different expansion coefficients, the two strips being secured by laminating, welding, bonding or directly by deposition for example by direct spraying of a second material on a first material as will be described in detail in the remainder of the description, so as to form a monolithic element.

The plate 2 comprises two bistable areas.

In the present application, “bistable area” is taken to mean an area able to take two stable positions, and to pass from one to the other under the effect of temperature or under the effect of a mechanical stress.

In the example represented, the bistable areas 4, 6 have a general shape of a circular bowl. Each of the stable positions has an opposite concavity. Each depression passes from one to the other. These bistable areas 4, 6 are formed for example by pressing or stamping of the plate 2.

Each of the bistable areas 4, 6 has its own thermal properties, i.e. its own blistering and unblistering temperatures.

The bistable area 4 has a blistering temperature Tc4 and an unblistering temperature Td4, and the bistable area 6 has a blistering temperature Tc6 and an unblistering temperature Td6.

Moreover, the bistable areas are arranged with respect to each other such that there is a mechanical coupling between them.

In FIGS. 3A and 3B may be seen two examples of relative arrangements of these bistable areas. Each area of depression is formed of a hollowed out area 4.1, 6.1 and of an external annular area 4.2, 6.2 surrounding the hollowed out area. Mechanical coupling between the two areas of depression is obtained when the two annular areas 4.1, 6.1 are sufficiently close or when they overlap, but without one of the annular areas overlapping a hollowed out area. The distance separating the edges of two neighbouring annular areas is determined as a function of the materials, the sag of the depression areas, the impact force, the temperature ranges in order to assure mechanical coupling between two areas of depression. Preferably, in the case of annular areas of diameter of the order of several centimetres, the distance separating the edges of two neighbouring annular areas is less than or equal to 1 cm.

As an example, in the case of an example of plates with two bistable areas: this can have a length of 50 mm and a width of 20 mm; the bistable areas have a diameter of 6 mm and the diameter of a bistable area and its annular area is 13 mm. The annular areas of the two bistable areas are in edge to edge contact.

In the case of a plate comprising an array of ten bistable areas spread out in two lines of five bistable areas, the plate has a length of 80 mm and a width of 35 mm; the diameter of the bistable areas is 7 mm and the diameter of the bistable area and its annular area is 16 mm. The annular areas are in edge to edge contact.

In a variant, the device could be formed by the assembly of several bimetallic strips each forming a bistable area. The materials of the bimetallic strips are chosen such that the bistable areas have different blistering and unblistering temperatures.

The blistering and unblistering temperatures of each of the bistable areas are chosen as a function of the temperature of the exterior environment, the temperature is designated TSC.

The blistering Tc and unblistering Td temperatures are such that:

Tc6<TSC<Tc4,

Td6<TSC<Td4,

Td6<Tc6 and Td4<Tc4.

The blistering and unblistering temperatures of each of the bistable areas 4, 6 are defined during the formation of the bistable areas, more particularly the hollowed out area and the annular area, by the choice of its diameter and its curvature.

As an example, for a plate having a length of 35 mm, a width of 20 mm and a thickness of 200 μm and comprising bistable areas, the diameter of which is 10 mm and the diameter of a bistable area and its annular area is 20 mm, the bistable areas have blistering and unblistering temperatures of 120° C. and 105° C. respectively.

The materials used to form the bimetallic strip are also chosen as a function of the temperature range in which the device is intended to operate.

For example, the bimetallic strip plate may be made based on Fe—Ni alloys of different compositions, such as INVAR®. These alloys may also contain chromium and/or manganese may be added. In a variant, it may be made of Si—Al, SiO2-Al, Si—Au, SiO2-Au, Si—Pb, SiO2-Pb, etc. The thicknesses of the bimetallic strips can vary from several nm to several mm as a function of the surface. As an example, the plate may have a thickness of 200 μm.

We will now explain the operation of the device in environments having different temperature conditions.

We will consider the case where the environment has a single substantially constant temperature, which will be designated TSC.

For reasons of simplicity of the explanation, we will take numerical examples which are in no way limiting.

TSC is equal to 30° C.

The temperatures Tc4 and Td4 of the bistable area 4 are chosen as follows:

Tc4=50° C. and Td4=40° C.

The temperatures Tc6 and Td6 of the bistable area 6 are chosen as follows:

Tc6=20° C. and Td6=10° C.

TSC being higher than Tc6, the bistable area 6 blisteres by means of a thermal effect and passes from one stable position to the other. The device in this state is represented in FIG. 1B. Due to the mechanical coupling between the two bistable areas 4, 6, the bistable area 4 also blisteres by collaborative mechanical effect under the effect of mechanical energy released during the blistering of the bistable area 6. It should be noted that since TSC is lower than Tc4, the bistable area 4 would not have blistered by means of a thermal effect. The device in this state is represented in FIG. 1C.

However TSC is lower than Td4, the bistable area 4 unblisteres to return to its initial state. The device in this state is represented in FIG. 1D.

By collaborative mechanical effect, the bistable area 6 unblisteres. It should be noted that since TSC is higher than Tc6, the bistable area 6 would not have unblistered by means of a thermal effect. The device in this state is represented in FIG. 1A.

Consequently, the conversion device according to the invention is capable of changing state without having available two heat sources at different temperatures and makes it possible to convert thermal energy into mechanical energy.

By arranging a piezoelectric material in contact with the bistable areas 4, 6, it is possible to convert this energy into electrical energy. In FIGS. 4A and 4B may be seen examples of an embodiment of a device converting the deformation energy of the bimetallic strip into electrical energy.

In FIG. 4A, a flexible piezoelectric material 10 covers one of the faces of the plate 2. The material 10 is for example a PVDF membrane.

In FIG. 4B, the piezoelectric material 10 is rigid and is deposited on the plate 2. This is of small size compared to the conversion device. It is for example PZT.

The thickness of the piezoelectric material is for example less than or equal to that of the bimetallic strip. As an example, the thickness of the bimetallic strip and the thickness of the PZT are equal to 200 μm.

A device having a very high oscillation frequency may be obtained, which makes it possible to load the piezoelectric element at high frequency and to generate a current.

In a variant, the device may form an electrode of a variable capacity capacitor. To do so, materials composing the bimetallic strip which are electrical conductors are chosen. The other electrode of the capacitor may be formed of a plate made of fixed conductive material arranged opposite the bimetallic strip.

The oscillation of the bimetallic strip causes a variation in the gap distance of the capacitor and thus a variation in its capacity which may be converted into variation of current or voltage by injection of electrical charges.

The device according to the invention may be used as detector of a temperature variation, it beginning to vibrate when the temperature of the environment attains a given value corresponding to the blistering and unblistering temperatures.

In a highly advantageous manner, it is possible to fix on the device a flexible sheet, for example made of plastic material, which is going to follow the oscillations of the device and deform in a corresponding manner.

The flexible sheet has a surface area greater than that of the device, however the deformations of the device are transmitted to the entire surface of the sheet, even to the areas that are not in contact with the device. The sheet is covered with a flexible piezoelectric material. Thus the surface area of piezoelectric material is greater than that of the device, which makes it possible to increase the amount of electricity produced.

We will now describe an example of device having an operating mode in which the device is in contact with a surface at a given temperature TSC and is arranged in an environment at a temperature lower than the given temperature, which does not intervene or hardly intervenes in the actuation of the conversion device. The surface will also be designated SC as the environment of FIGS. 1A to 1D and its temperature TSC.

In this example, the bistable areas have the following thermal properties:

Tc6<TSC<Tc4 and TSC<Td4.

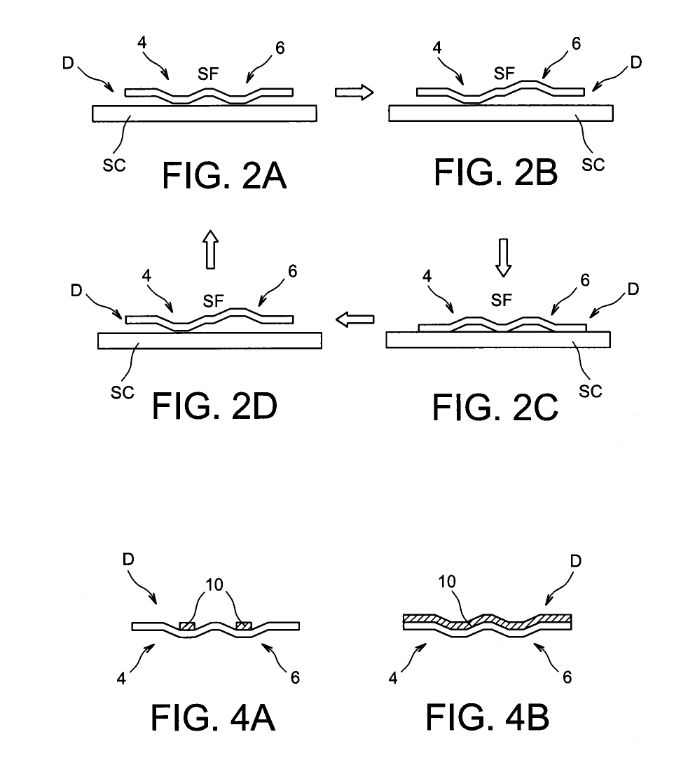

In FIGS. 2A to 2D are represented the different states of a device according to the invention in contact with a surface SC and arranged in an environment SF.

As an example, the temperature of the surface SC is equal to 150° C. and a temperature for the exterior environment SF is equal to 30° C.

For example, one chooses:

Tc4=180° C. and Td4=160° C.;

Tc6=120° C. and Td6=100° C.

The temperature of the surface SC being higher than Tc6, the bistable area 6 blisteres by means of a thermal effect and passes from one stable position to the other. The device in this state is represented in FIG. 2B. By collaborative mechanical effect the bistable area 4 also blisteres under the effect of mechanical energy released during the blistering of the bistable area 6, as may be seen in FIG. 2C. It should be noted that since the temperature of the surface SC is lower than Tc4, the bistable area 4 would not have blistered by means of a thermal effect.

The temperature of the surface SC being lower than Td4, the bistable area 4 unblisteres to return to its initial state, as may be seen in FIG. 2D, which has the effect of mechanically driving the bistable area 6. The device is in the state of FIG. 2A.

The steps described above are repeated as long as the temperature of the surface SC is higher than Tc6 and is lower than Td4.

Thus the device operates independently of the temperature of the environment.

Conversely, the device may be arranged in an environment at a given temperature and be in contact with a surface at a temperature lower than that of the environment. The temperature of the surface does not intervene or hardly intervenes in the actuation of the device.

We will now describe an embodiment example of a device in which the start of oscillation is controlled by the temperature of a surface at a given temperature TSC and by the temperature of the exterior environment TSF which is lower than the given temperature TSC.

In this example, the bistable areas have the following thermal properties:

Tc6<TSC<Tc4

TSF<Td4

As an example, TSC is equal to 50° C. and TSF is equal to 30° C.

For example, one chooses:

Tc4=60° C. and Td4=40° C.;

Tc6=40° C. and Td6=20° C.

The temperature TSC being higher than Tc6, the bistable area 6 blisteres by means of a thermal effect and passes from one stable position to the other. By collaborative mechanical effect the bistable area 4 also blisteres under the effect of the mechanical energy released during the blistering of the bistable area 6. It should be noted that since the temperature TSC is lower than Tc4, the bistable area 4 would not have blistered by means of a thermal effect.

The temperature of the environment is lower than Td4, the bistable area 4 unblisteres to return to its initial state.

By collaborative mechanical effect, the bistable area 6 unblisteres. It should be noted that since the temperature of the exterior environment is higher than Tc6, the bistable area 6 would not have blistered by means of a thermal effect. The device in this state is represented in FIG. 2A.

The steps described above are repeated as long as the temperature TSC is higher than TC6 and the temperature of the exterior environment is lower than Td4.

Thus the device according to the invention can operate when it is subjected to a single given temperature. It can also function when it experiences two temperatures. Its application areas are thus very vast.

For example the difference between Tc4 and Tc6 may be very small for example 1° C., but this is going to depend on the precision of the given temperature TSC since Tc6<TSC<Tc2.

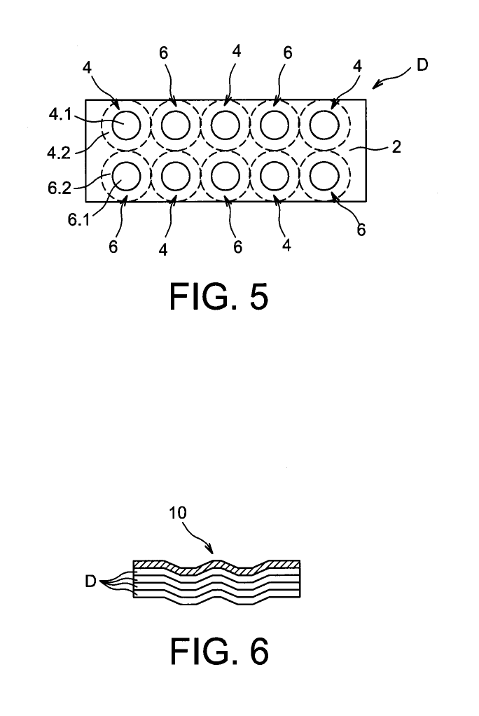

In FIG. 5 may be seen a conversion device comprising an array of ten bistable areas. The neighbouring bistable areas have different blistering and unblistering temperatures.

In the example represented, the annular areas 4.2 and 6.2 of two neighbouring bistable areas are in contact.

In the example of FIG. 5, the bistable areas 4 and 6 are alternating so as to create the collaborative effect.

All the bistable areas may have blistering and unblistering temperatures such that they change state for a reduced temperature range.

Alternatively, the bistable areas may have sufficiently different blistering and unblistering temperatures so as to cover a wide temperature range, thus enabling the device to oscillate over a wide temperature range for the given temperature TSC.

It is possible to envisage groups of bistable areas having the same blistering and unblistering temperatures, the bistable areas of each group being spread out in the bimetallic strip so as to be neighbouring with a bistable area of another group to assure collaborative operation.

In these conditions, at a given temperature TSC1, first bistable areas blistere by means of a thermal effect, which drives the blistering of second neighbouring bistable areas by mechanical effect.

These second bistable areas unblistere because they are in their range of unblistering temperature by means of a thermal effect, driving the unblistering of the first bistable areas by mechanical effect.

At another temperature TSC2, it is another group of bistable areas which blisteres, driving the blistering of the other bistable areas by mechanical effect.

Thus, over a wide temperature range, the device still has a group of thermally active bistable areas, and which mechanically drive the other bistable areas.

The heat source in the case of the examples of FIGS. 2A to 2D may be variable, over time and in space. For example in the latter case, it is possible to envisage that the conversion device is in contact with a surface exhibiting a temperature gradient from one end to the other of the surface.

Different bistable areas may thus blistere or unblistere simultaneously by means of a thermal effect, and drive by collaborative effect neighbouring bistable areas.

In another embodiment example, the conversion device may comprise at least two bistable areas 4, 6 such that:
Tc4>Tc6

and
Td6>Td4.

Thus, when the bistable area 6 blisteres by means of a thermal effect, it drives the bistable area 4 by collaborative effect, then once again the bistable area 6 unblisteres by means of a thermal effect, driving the bistable area 4.

Alternatively, a trimetallic strip structure may be used instead of a bimetallic strip structure. A trimetallic strip is an element comprising three layers of materials, two end layers and a central layer, the central layer having a different expansion coefficient to the material(s) of the end layers. For example the external layers are made of a same material.

By using a trimetallic strip in which the end layers are made of the same material, it is possible to form bistable areas on both faces of the plate, said bistable areas having the same thermal properties because they have “the same composition of layers and the same sequencing of layers”. Moreover, the bistable areas may be closer together.

In the examples described such as that of FIG. 5, the device is in the form of a flat plate. It is possible to envisage a non-flat device, for example with one or more curvatures and/or one or more flat portions so that it follows the contour of a non-flat surface and is in contact therewith.

In the example of FIG. 5, the device extends in a plane. Devices extending in three dimensions may be envisaged.

In a very advantageous manner, the stack of devices such as that of FIGS. 1A to 1B makes it possible to amplify the energy released during the blistering of the bistable areas. Such a device is represented in FIG. 6. A piezoelectric material 10 covers one end of the stack. This then experiences a large energy released during blistering or unblistering, which increases the amount of electricity generated by the piezoelectric material.

It is also possible to envisage coupling several devices according to the invention. It is possible for example to envisage a device in which devices such as that of FIG. 4 could be arranged on either side of a same object at the given temperature TSC. The device would then be symmetrical with respect to said object. It is possible to associate several devices oscillating at different temperatures to restart or to maintain the oscillations.

The bimetallic strips or trimetallic strips may have a shape other than a rectangle, and may have non-constant thicknesses.

Moreover, in a highly advantageous manner, the device may be hollowed out in areas not comprising bistable areas so as to reduce the amount of bimetallic strip material and to reduce the time necessary for the thermalization of the bistable areas and thus for their change of state. These hollowings out may be situated at the ends of the plate of FIG. 5.

In the operating examples, the blistering or unblistering of a bistable area drives the blistering or unblistering of a neighbouring area by mechanical coupling. In the case of a device comprising several bistable areas, it is possible to envisage that a bistable area changing state by collaborative effect drives in its turn the change of state of a neighbouring bistable area, or that a bistable area changing state by means of a thermal effect causes in its turn the change of state of a neighbouring bistable area.

The conversion device according to the invention may be associated with an electronic device to convert the heat produced by the electronic components into electricity which could be consumed by the electronic device itself for example. It may be applied in automobile vehicles at the level of the heat engine or an electric battery or in any other installation producing heat that may be converted.

1: Device for converting heat energy into mechanical energy comprising at least one first and one second bistable area, able to pass from a first stable state to a second stable state by means of a thermal effect or mechanical action, said bistable areas being mechanically coupled such that the passage from one stable state to the other of one of the bistable areas by means of a thermal effect causes the passage from one stable state to the other of the other bistable area, each of said bistable areas having a first temperature at which it passes from the first stable state to the second stable state and a second temperature at which it passes from the second stable state to the first stable state, the first temperature being higher than the second temperature, and in which the first temperature of the first bistable area is higher than the first temperature of the second bistable area.

2: Conversion device according to claim 1, in which the bistable areas are made in one piece of a bimetallic strip element.

3: Conversion device according to claim 1, in which the bistable areas are made of a trimetallic strip element.

4: Conversion device according to claim 3, in which the element formed comprises two opposing faces, bistable areas being formed in each of the faces.

5: Conversion device according to claim 1, in which the bistable areas are formed by pressing.

6: Conversion device according to claim 1, in which the bistable areas comprise a central depression and an annular area surrounding the central depression, said annular areas overlapping or being in contact via their external contours.

7: Conversion device according to claim 1, comprising a plurality of bistable areas arranged alongside each other such that neighbouring bistable areas have different first temperatures.

8: Conversion device according to claim 1, in which said device comprises hollowed out portions between the bistable areas.

9: Conversion assembly for converting heat energy into electrical energy, comprising at least one conversion device according to claim 1 and an environment or a surface at a given temperature or an environment having a first and a second given temperature.

10: Conversion assembly according to claim 9, in which the given temperature is lower than the first temperature of the first bistable area and the second temperature of the first bistable area and is higher than the first temperature of the second bistable area.

11: Conversion assembly according to claim 9, in which the first given temperature is higher than the second given temperature and in which the first given temperature is lower than the first temperature of the first bistable area and is higher than the first temperature of the second bistable area and the second given temperature is lower than the second temperature of the first bistable area.

12: Conversion assembly according to claim 9 comprising two conversion devices.

13: System for generating electrical energy comprising at least one conversion device according to claim 1, and means for converting the mechanical energy generated by said conversion device into electrical energy.

14: System for generating electrical energy according to claim 13, in which the means for converting the mechanical energy generated by said conversion device into electrical energy comprise at least one element made of piezoelectric material arranged on the conversion device so as to be deformed by the changes of state of the bistable areas.

15: System for generating electrical energy comprising a stack of conversion devices according to claim 1, in which the means for converting the mechanical energy generated by said stack of conversion devices into electrical energy comprise at least one element made of piezoelectric material arranged on an electrical energy conversion device situated at one end of the stack.

16: System for generating electrical energy according to claim 13, in which the means for converting the mechanical energy generated by said electrical energy conversion device comprise at least one variable capacity capacitor, an electrode of said variable capacity capacitor being formed or borne by the electrical energy conversion device.

17: Use of a conversion device according to claim 1, in which said device is arranged in an environment at a given temperature or in contact with a surface at a given temperature, such that the given temperature is lower than the first temperature and is lower than the second temperature of the first bistable area and is higher than the first temperature of the second bistable area.

18: Use of a conversion device according to claim 1, in which said device is subjected to a first given temperature and a second given temperature such that the first given temperature is higher than the second given temperature and such that the first given temperature is lower than the first temperature of the first bistable area and is higher than the first temperature of the second bistable area and the second given temperature is lower than the second temperature of the first bistable area.
